(19) United States
(12) Patent Application Publication
(10) Pub. No.: US 2026/0014676 A1
(43) Pub. Date: Jan. 15, 2026

(54) ADJUSTABLE WRENCH

(71) Applicant: HANGZHOU GREAT STAR INDUSTRIAL CO., LTD., Hangzhou City (CN)

(72) Inventor: Feng LI, Hangzhou City (CN)

(21) Appl. No.: 19/332,634

(22) Filed: Sep. 18, 2025

Related U.S. Application Data
(63) Continuation-in-part of application No. PCT/CN2023/139358, filed on Dec. 18, 2023.

(30) Foreign Application Priority Data
Mar. 20, 2023 (CN) 202310281683.1

(51) Int. Cl. B25B 13/14

(52) U.S. Cl. CPC B25B 13/14

(57) ABSTRACT

An adjustable wrench, comprising: a handle; and a fixed jaw and an adjustable jaw that are arranged at one end of the handle; wherein an abutment position of the fixed jaw and the handle is provided with a track slot, and two sides of the track slot extend to form two opposite side walls; the adjustable jaw comprises a shaft portion, a neck portion, and a clamping portion; the shaft portion is accommodated in the track slot and is configured to move along the track slot; the clamping portion protrudes out of the track slot and is configured to cooperate with the fixed jaw to clamp a workpiece; and the neck portion is located between the two opposite side walls; wherein the adjustable wrench further comprises a constraint structure, and the constraint structure is configured to prevent the two opposite side walls from opening when applying a torque to the workpiece clamped between the adjustable jaw and the fixed jaw.

### CROSS-REFERENCE TO RELATED APPLICATIONS

This application is a continuation-in-part (CIP) application claiming benefit of PCT/CN2023/139358, filed on Dec. 18, 2023, which claims priority to Chinese Patent Application No. 202310281683.1, filed on Mar. 20, 2023, the disclosures of which are incorporated herein in their entirety by reference.

### TECHNICAL FIELD

The present invention relates to the field of manual tools, and in particular to an adjustable wrench.

### BACKGROUND ART

An adjustable wrench is a manual tool for applying torque to nuts, bolts, etc. The adjustable wrench has a fixed jaw and an adjustable jaw. By turning a worm to rotate, a worm wheel is driven to carry the fixed jaw to move relative to the adjustable jaw, thus adjusting the spacing between the adjustable jaw and the fixed jaw, so as to clamp workpieces of different specifications and apply torques to the workpieces.

The worm wheel and the worm have a self-locking capability. When a workpiece is initially clamped by turning the worm wheel, the adjustable jaw is locked at an initial clamping position. When a torque is applied to the workpiece, the adjustable jaw can always clamp the workpiece, thus maintaining an ideal working state of the adjustable wrench.

However, when the torque is applied to the workpiece through the adjustable wrench, the torque applied to the adjustable wrench and a reaction force from the workpiece will cause slight deformation of the adjustable jaw and a stress bearing position in contact with the adjustable jaw. For example, side walls on two sides of a neck portion of the adjustable jaw will tilt towards an outer side, thus losing a function of limiting the position of the worm, and thus causing the worm wheel arranged on the adjustable jaw to deviate from the worm to increase the fit clearance between the worm wheel and the worm.

The above factors will cause the fit between the worm wheel and the worm to become too loose (excessive fit clearance) when the torque is applied to the workpiece through the adjustable wrench, thus making it unable to keep the adjustable jaw at the initial clamping position, causing slight displacement of the adjustable jaw, making the spacing between the adjustable jaw and the fixed jaw increase, and making it unable to clamp the workpiece and apply an effective torque. In severe cases, it will also cause the workpiece to slip between the adjustable jaw and the fixed jaw, thus causing the maximum torque that the adjustable wrench can apply to the workpiece to be small.

Therefore, those skilled in the art are committed to developing an adjustable wrench that maintains the fit clearance between the worm wheel and worm when applying a torque to a workpiece to increase the maximum torque applied by the adjustable wrench to the workpiece.

### SUMMARY OF THE INVENTION

In view of the above-mentioned defects of the existing technology, the technical problem to be solved by the present invention is to overcome the defect that the maximum torque that the adjustable wrench can apply to the workpiece is caused to be small because the fit clearance between the worm wheel and the worm increases when the adjustable wrench applies the torque to the workpiece.

To achieve the above objectives, the present invention provides an adjustable wrench, comprising:
a handle; and
a fixed jaw and an adjustable jaw that are arranged at one end of the handle;
wherein an abutment position of the fixed jaw and the handle is provided with a track slot, and two sides of the track slot extend to form two opposite side walls;
the adjustable jaw comprises a shaft portion, a neck portion, and a clamping portion; the shaft portion is accommodated in the track slot and is configured to move along the track slot; the clamping portion protrudes out of the track slot and is configured to cooperate with the fixed jaw to clamp a workpiece; and the neck portion is located between the two opposite side walls;
wherein the adjustable wrench further comprises a constraint structure, and the constraint structure is configured to prevent the two opposite side walls from opening when applying a torque to the workpiece clamped between the adjustable jaw and the fixed jaw.

Further, the constraint structure comprises clamping grooves arranged on two sides of the neck portion and top profiles of the two opposite side walls, wherein openings of the clamping grooves face towards the side walls, shapes of the top profiles match shapes of the clamping grooves, and the top profiles are accommodated in the clamping grooves.

Further, the clamping grooves are formed by intersecting a first surface with a side surface of the neck portion, and the first surface at least comprises an inclined surface obliquely extending towards the side walls; and the top profiles comprise a second surface that matches the first surface.

Further, the first surface comprises at least two geometric surfaces that are sequentially joined.

Further, the first surface comprises a first flat surface and a first inclined surface that are sequentially joined, and the first flat surface intersects with the side surface of the neck portion; the second surface includes a second flat surface that matches the first flat surface and a second inclined surface that matches the first inclined surface; wherein the first flat surface and the second flat surface are both perpendicular to an inner side surface of the side wall, and the first inclined surface and the second inclined surface respectively form acute angles with the inner side surface of the side wall.

Further, the first inclined surface and the second inclined surface are both flat surfaces.

Further, the first inclined surface and the second inclined surface are both curved surfaces.

Further, the first surface comprises a first oblique surface, and the second surface comprises a second oblique surface that matches the first oblique surface.

Further, the first oblique surface and the second oblique surface are both flat surfaces, and the first oblique surface and the second oblique surface respectively form acute angles with an inner side surface of the side wall.

Further, the first surface comprises a first curved surface, and the second surface comprises a second curved surface that matches the first curved surface.

Further, a width of the first surface is greater than a width of the second surface.

Further, the clamping grooves further comprise an ear arranged opposite to the neck portion, the ear extends from an outer side of the first surface towards the handle, and an inner side of the ear contacts an outer side surface of the side wall.

Further, one end of the track slot close to the fixed jaw is a closed end, and another end of the track slot is an open end; the constraint structure comprises a reinforcement portion connected between the two opposite side walls, and the reinforcement portion abuts the open end.

Further, the reinforcement portion is a rod-shaped member welded between the two opposite side walls.

Further, the reinforcement portion is a rod-shaped member assembled between the two opposite side walls.

Further, the constraint structure is such that a thickness of the side wall gradually increases from a top surface of the side wall towards the track slot.

Further, a thickness W of a root of the side wall and a radius R of the track slot satisfy W≥0.8R.

Further, the two sides of the neck portion and top surfaces of the two opposite side walls form inclined flat surfaces, and the inclined flat surfaces form obtuse angles with inner side surfaces of the side walls.

Further, the constraint structure is formed by a combination of any two of the following structures or by a combination of the following structures:
i. clamping grooves arranged on two sides of the neck portion and top profiles of the two opposite side walls, wherein openings of the clamping grooves face towards the side walls, shapes of the top profiles match shapes of the clamping grooves, and the top profiles are accommodated in the clamping grooves;
ii. a reinforcement portion connected between the two opposite side walls, wherein the reinforcement portion abuts an open end of the track slot;
iii. a thickness of the side wall gradually increases from a top surface of the side wall towards the track slot.

Further, the shaft portion comprises a symmetrical curved surface, and the shaft portion is in sliding fit with a wall of the track slot through the curved surface.

In the present invention, by arranging the constraint structure for the two opposite side walls, the constraint structure prevents the two opposite side walls from opening when applying the torque to the workpiece clamped between the adjustable jaw and the fixed jaw through the handle, thus preventing the fit clearance between the tooth portion of the adjustable jaw and the worm from increasing, and maintaining the fit clearance between the tooth portion and the worm to increase the maximum torque applied by the adjustable wrench to the workpiece.

The concept, specific structure, and technical effects of the present invention will be further described below with reference to the accompanying drawings, so as to fully understand the objectives, features, and effects of the present invention.

### BRIEF DESCRIPTION OF THE DRAWINGS

FIG. 1 is an axonometric view of an adjustable wrench according to embodiment 1 of the present invention;

FIG. 2 is an exploded structural schematic diagram and a partial enlarged diagram of the adjustable wrench in FIG. 1;

FIG. 3 is an orthographic projection schematic diagram of the adjustable wrench in FIG. 1;

FIG. 4 is an A-A sectional view of FIG. 3;

FIG. 5 is a right view of FIG. 3;

FIG. 6 is a B-B sectional view of FIG. 5;

FIG. 7 is a schematic diagram of a first surface of a clamping groove which is an oblique flat surface;

FIG. 8 is an exploded schematic diagram of an adjustable wrench according to embodiment 2 of the present invention;

FIG. 9 is an orthographic projection schematic diagram of the adjustable wrench in FIG. 8;

FIG. 10 is a C-C sectional view of FIG. 9;

FIG. 11 is a right view of FIG. 9;

FIG. 12 is a D-D sectional view of FIG. 11;

FIG. 13 is an axonometric view of an adjustable wrench according to embodiment 3 of the present invention;

FIG. 14 is an axonometric view of an adjustable wrench according to embodiment 4 of the present invention;

FIG. 15 is an exploded structural schematic diagram of the adjustable wrench in FIG. 14;

FIG. 16 is an orthographic projection schematic diagram of the adjustable wrench in FIG. 14;

FIG. 17 is an E-E sectional view of FIG. 16;

FIG. 18 is a right view of FIG. 16;

FIG. 19 is an F-F sectional view of FIG. 18; and

FIG. 20 is a sectional view of an adjustable wrench according to embodiment 5 of the present invention.

### DESCRIPTION OF REFERENCE SIGNS

100—handle;
200—fixed jaw;
300—junction position;
400—adjustable jaw: 401—shaft portion, 402—neck portion, 403—first flat surface, 404—first inclined surface, 405—tooth portion, 406—clamping groove, 407—curved surface, 408—first curved surface, 409—flat surface, 410—inclined flat surface, 411—side surface of neck portion, 412—first surface, 413—first oblique surface, 414—ear
500—track slot, 501—closed hole, 502—open end;
600—side wall, 601—top profile, 602—inner side surface, 603—second surface, 604—second flat surface, 605—second inclined surface, 606—second oblique surface, 607—second curved surface, 608—outer side surface, 610—accommodating space,
700—worm, 701—pin shaft;
800—reinforcement portion;
900—workpiece;
h1—width of first curved surface, h2—width of second curved surface, W—thickness of root of side wall, R—radius of track slot.

### DETAILED DESCRIPTION OF EMBODIMENTS

Multiple preferred embodiments of the present invention will be introduced below with reference to the accompanying drawings, so as to make its technical content clearer and easier to understand. The present invention may be embodied through many different forms of embodiments. the scope of protection of the present invention is not limited to the embodiments mentioned herein.

The terms “comprise”, “have”, and any variations thereof in the description and claims of the present invention are intended to cover non-exclusive inclusions. For example, a method or product containing a series of technical features is not necessarily limited to those clearly listed, but may also include other technical features that are not clearly listed and can be included in the method or product.

In the description of the present invention, it needs to be understood that the technical features defined by the terms such as “first” and “second” with a sequential concept are only intended to clearly describe the defined technical features, so that the defined technical features can be distinguished from other technical features, do not represent such naming in actual implementation, and thus cannot be understood as limiting the present invention.

In the accompanying drawings, components with the same structure are labeled with the same numbers, and components with similar structures or functions are labeled with similar numbers. The size and thickness of each component shown in the accompanying drawings are arbitrary. The present invention does not limit the size and thickness of each component. In order to make the illustration clearer, the thickness of some components in the accompanying drawings has been appropriately exaggerated.

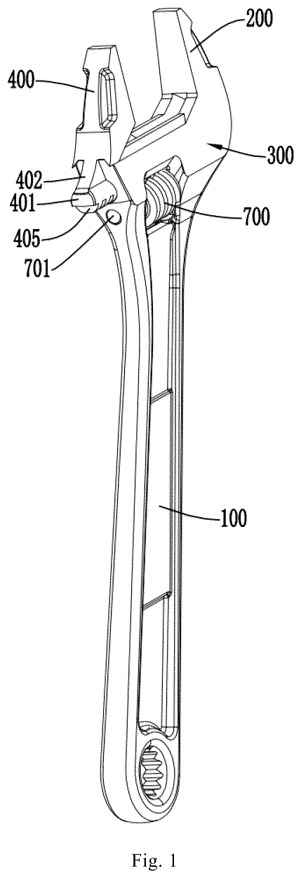

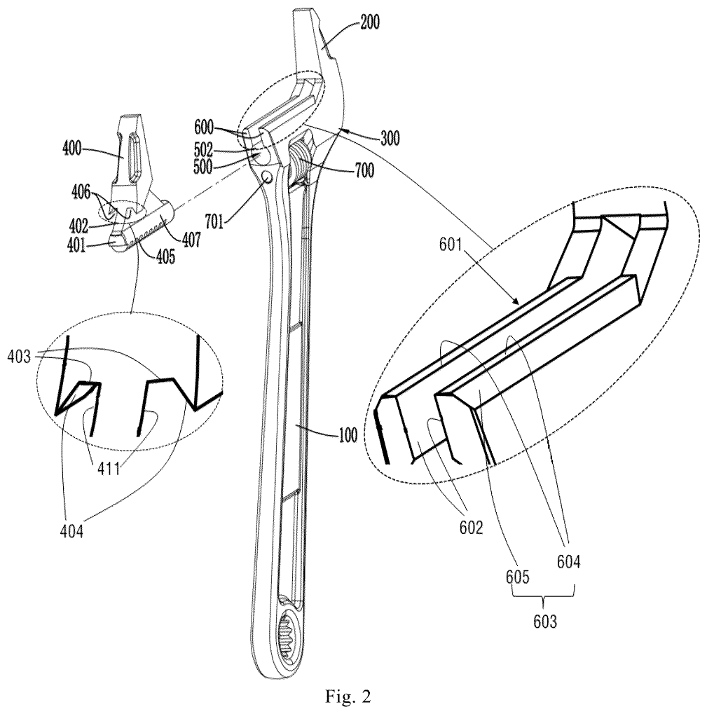

As shown in FIG. 1 and FIG. 2, an adjustable wrench provided in the present invention comprises a handle 100, a fixed jaw 200 arranged at one end of the handle 100, and an adjustable jaw 400 arranged opposite to the fixed jaw 200 and movable relative to the fixed jaw 200. An abutment position 300 of the handle 100 and the fixed jaw 200 is provided with a track slot. Two opposite side walls extend from two sides of the track slot. An accommodating space 610 running along a thickness direction of the junction position 300 is arranged below the side walls. The accommodating space 610 is communicated with the track slot. A rotatable worm is assembled in the accommodating space 610 through a pin shaft 701. The adjustable jaw 400 comprises a shaft portion 401, a neck portion 402, and a clamping portion. The shaft portion 401 is accommodated in the track slot and can move back and forth along a length direction of the track slot. The shaft portion 401 is provided with a tooth portion 405 meshing with the worm. By rotating the worm, the adjustable jaw 400 can be controlled to move back and forth along the track slot. The clamping portion protrudes out of the track slot and cooperates with the fixed jaw 200 to clamp a workpiece. The neck portion 402 is located between the two opposite side walls of the track slot.

As shown in FIG. 4 and FIG. 6, when the adjustable jaw 400 cooperates with the fixed jaw 200 to clamp the workpiece, a torque is applied to the handle 100, and the adjustable jaw 400 and the fixed jaw 200 apply the torque to the workpiece 900. At this time, the adjustable jaw 400 will receive a reaction force N from the workpiece 900, and the reaction force N will apply a torque M to the adjustable jaw 400 as shown by an arc arrow in the figure. As shown in FIG. 4, the torque applies a thrust force F to the two opposite side walls 600 of the track slot 500 through the shaft portion 401. Under the action of the thrust force F, the two opposite side walls 600 will open and tilt, losing a function of limiting the position of the worm 700 or causing this trench to occur, thus causing the adjustable jaw 400 and a stress bearing position in contact with the adjustable jaw 400 to deform slightly, ultimately causing the tooth portion 405 of the adjustable jaw 400 to deviate from the worm 700 to increase the fit clearance between the worm 700 and the tooth portion 405, causing the spacing between the adjustable jaw 400 and the fixed jaw 200 to increase, making it impossible to clamp the workpiece 900 and apply an effective torque, further causing the workpiece 900 to slip between the adjustable jaw 400 and the fixed jaw 200 in severe cases, and causing the maximum torque that the adjustable wrench can apply to the workpiece 900 to be very small.

In the present invention, by arranging the constraint structure for the two opposite side walls 600, the two opposite side walls 600 can be prevented from opening when the two opposite side walls 600 apply the torque to the workpiece 900 clamped between the adjustable jaw 400 and the fixed jaw 200, thus preventing the fit clearance between the worm 700 and the tooth portion 405 from increasing, so as to maintain the fit clearance between the worm 700 and the tooth portion 405 to increase the maximum torque applied by the adjustable wrench to the workpiece 900. The present invention will be introduced below in detail through multiple embodiments.

### Embodiment 1

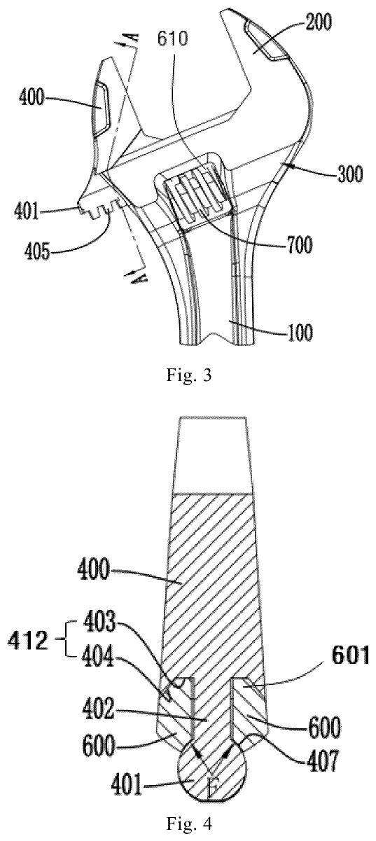

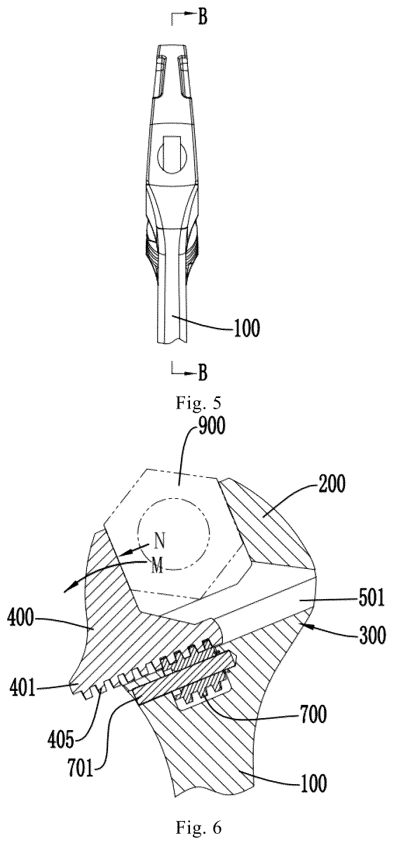

FIG. 1 to FIG. 7 depict embodiment 1. As shown in FIG. 1 and FIG. 2, an adjustable wrench provided in the present invention comprises a handle 100, a fixed jaw 200 arranged at one end of the handle 100, and an adjustable jaw 400 arranged opposite to the fixed jaw 200 and movable relative to the fixed jaw 200. An abutment position 300 of the handle 100 and the fixed jaw 200 is provided with a track slot 500. Two opposite side walls 600 extend from two sides of the track slot 500. An accommodating space 610 running along a thickness direction of the junction position 300 is arranged below the side walls 600. The accommodating space 610 is communicated with the track slot 500. A rotatable worm 700 is arranged in the accommodating space 610. The adjustable jaw 400 comprises a shaft portion 401, a neck portion 402, and a clamping portion. The shaft portion 401 is accommodated in the track slot 500 and can move back and forth along a length direction of the track slot 500. The shaft portion 401 is provided with a tooth portion 405 meshing with the worm 700. By rotating the worm 700, the adjustable jaw 400 can be controlled to move back and forth along the track slot 500. The clamping portion protrudes out of the track slot 500 and cooperates with the fixed jaw 200 to clamp a workpiece 900. The neck portion 402 is located between inner side surfaces 602 of the two opposite side walls 600 of the track slot 500.

A constraint structure comprises clamping grooves 406 arranged on two sides of the neck portion 402 of the adjustable jaw 400, and top profiles 601 of the two opposite side walls 600 in contact with the clamping grooves 406 and matching shapes of the clamping grooves 406. Openings of the clamping grooves 406 face towards the two opposite side walls 600 of the track slot 500. The clamping grooves 406 are formed by intersecting a first surface 412 with a side surface 411 of the neck portion 402, wherein the first surface 412 at least comprises inclined surfaces obliquely extending towards the side walls 600, and the inclined surfaces form acute angle with inner side surfaces 602 of the side walls 600 of the track slot 500. The top profiles 601 of the side walls 600 comprise a second surface 603 that matches a shape of the first surface 412. When the adjustable jaw 400 is mounted in the track slot 500, the side surface 411 of the neck portion 402 is opposite to the inner side surfaces 602 of the side walls 600, and the first surface 412 is in contact with the second surface 603. When two opposite side walls 600 open or tend to open, the clamping grooves 406 form a constraint on the side walls 600, thus preventing the two opposite side walls 600 from opening.

In some embodiments, the clamping grooves 406 are located at one end of the adjustable jaw 400 away from the fixed jaw 200. As shown in FIG. 6, one end of the track slot 500 is a closed hole 501, and the closed hole 501 abuts the fixed jaw 200. As shown in FIG. 2, the other end of the track slot 500 is an open end 502, the open end 502 is far away from the fixed jaw 200, the adjustable jaw 400 slides in the track slot 500, and the clamping grooves 406 are located on one end of the adjustable jaw 400 away from the fixed jaw 200.

In some embodiments, as shown in FIG. 2 and FIG. 4, the first surface 412 comprises at least two geometric surfaces that are sequentially joined, that is, the clamping grooves 406 are formed by the side surface 411 of the neck portion 402 and at least two geometric surfaces that are sequentially joined. When the adjustable jaw 400 is mounted in the track slot 500, the side surface 411 of the neck portion 402 is opposite to inner side surface 602 of the side walls 600, and the shapes of the top profiles 601 of the side walls 600 match the geometric surfaces that are sequentially joined, so that the tops of the side walls 600 fall into the clamping grooves 406, that is, the clamping grooves 406 cover the top profiles 601 of the side walls 600, thus restricting the two side walls 600 from opening. For example, the first surface 412 of the clamping groove 406 comprises a first flat surface 403 and a first inclined surface 404 that is joined with the first flat surface 403. Correspondingly, the second surface 603 of the top profile 601 of the side wall 600 of the track slot 500 comprises a second flat surface 604 that contacts the first flat surface 403 and a second inclined surface 605 that contacts the first inclined surface 404. The first flat surface 403 and the second flat surface 604 are both perpendicular to the inner side surface 602 of the side wall 600. An obtuse angle is formed between the first inclined surface 404 and the first flat surface 403. An obtuse angle is formed between the first second inclined surface 605 and the second flat surface 604. Both the first inclined surface 404 and the second inclined surface 605 form an acute angle with the inner side surface 602 of the side wall 600. Accordingly, the first flat surface 403, the first inclined surface 404, and the side surface 411 of the neck portion 402 form the clamping groove 406, the second flat surface 604 and the second inclined surface 605 form the top profile 601 of the side wall 600, and the top profile 601 matches the shape of the clamping groove 406. Preferably, the first inclined surface 404 and the second inclined surface 605 are both flat surfaces.

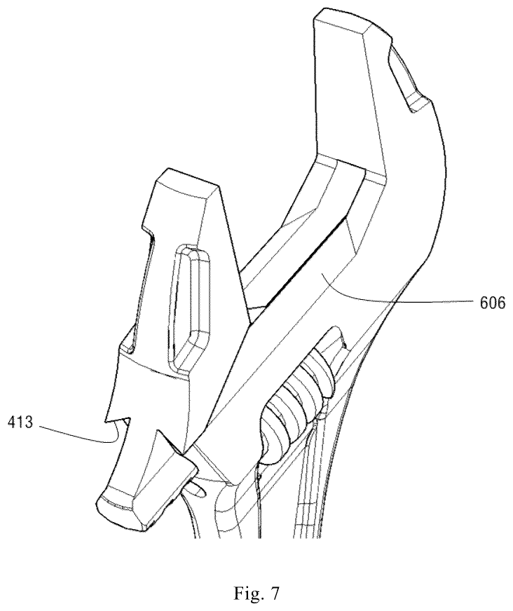

In some embodiments, as shown in FIG. 7, the first surface 412 comprises a first oblique surface 413, that is, the clamping groove 406 is formed by the side surface 411 of the neck portion 402 and the first oblique surface 413. Referring to the figures, the first oblique surface 413 obliquely extends towards the handle 100, the first oblique surface 413 intersects with the side surface 411 of the neck portion 402, and an acute angle is formed between the two, thus forming the clamping groove 406. The second surface 603 of the top profile 601 of the side wall 600 comprises a second oblique surface 606 that intersects with the inner side surface 602 of the side wall 600 at an acute angle, and the second oblique surface 606 contacts the first oblique surface 413. Preferably, the first oblique surface 413 and the second oblique surface 606 are both flat surfaces.

In some embodiments, as shown in FIG. 4, the shaft portion 401 comprises a symmetrical curved surface 407, and the curved surface 407 is in sliding fit with the wall of the track slot 500. When the adjustable jaw 400 is subjected to a torque M as shown in the figure, the shaft portion 401 has a larger contact area with the wall of the track slot 500 as shown in the figure, thus increasing the ability of the contact position to resist plastic deformation and increasing the service life of the adjustable wrench.

The working principle of the adjustable wrench in this embodiment is as follows: the adjustable jaw 400 and the fixed jaw 200 clamp the workpiece 900. When a torque is applied to the workpiece 900 through the wrench, the adjustable jaw 400 will be subjected to a reaction force N from the workpiece 900. The reaction force N will apply a torque M to the adjustable jaw 400 as indicated by an arc arrow shown in the figure. The torque will apply a thrust force F to the two side walls 600 through the shaft portion 401 as shown in FIG. 4. In a case that the two side walls 600 are not constrained, the thrust force F will cause the two opposite side walls 600 to open and tilt, losing a function of limiting the position of the worm 700 or showing this trend, thus causing the adjustable jaw 400 and a stress bearing position in contact with the adjustable jaw 400 to deform slightly, ultimately causing the tooth portion 405 of the adjustable jaw 400 to deviate from the worm 700 to increase the fit clearance between the tooth portion 405 and the worm 700, causing the spacing between the adjustable jaw 400 and the fixed jaw 200 to increase, making it impossible to clamp the workpiece 900 and apply an effective torque, further causing the workpiece 900 to slip between the adjustable jaw 400 and the fixed jaw 200 in severe cases, and causing the maximum torque that the adjustable wrench can apply to the workpiece 900 to be very small. In this embodiment, since the clamping grooves 406 cover the top profiles 601 of the two side walls 600, a constraint is formed on the two side walls 600, thus preventing the two side walls 600 from opening and forming a clamping effect on the two opposite side walls 600. Therefore, the two side walls 600 are prevented from opening under the action of the thrust force F, thus maintaining the fit relationship between the tooth portion 405 and the worm 700, and preventing the spacing between the tooth portion 405 and the worm 700 from increasing, so as to increase the maximum torque applied by the adjustable wrench to the workpiece 900.

### Embodiment 2

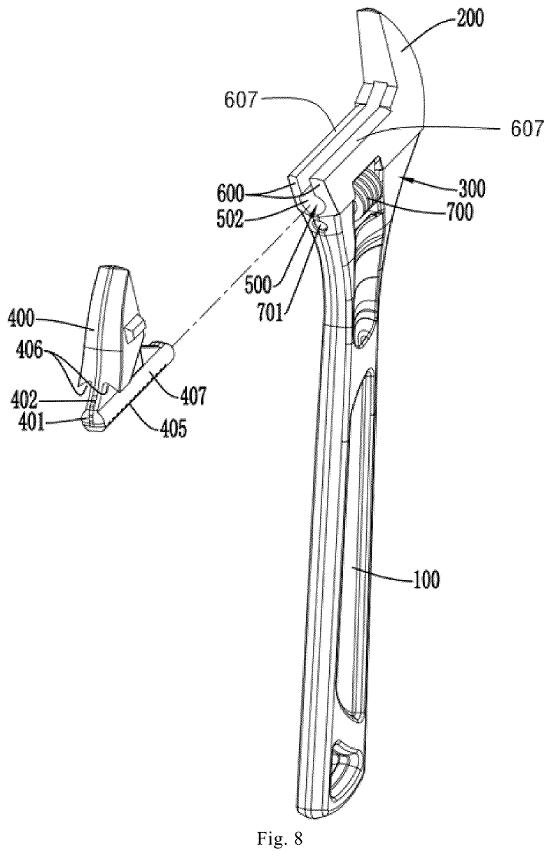

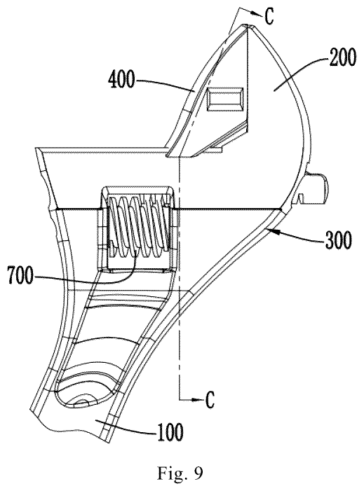

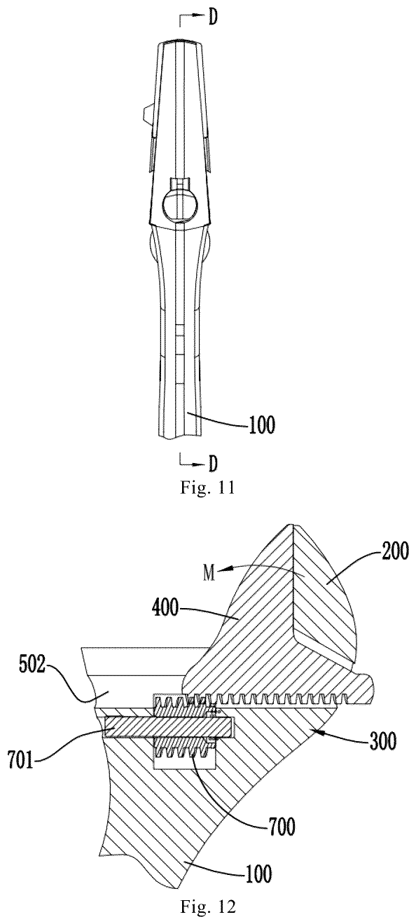

FIG. 8 to FIG. 12 show this embodiment. In this embodiment, a difference of the adjustable wrench from the adjustable wrench in embodiment 1 only lies in that the shape of the clamping grooves 406 and the shape of the top profiles 601 of the side walls 600 are different from those in embodiment 1.

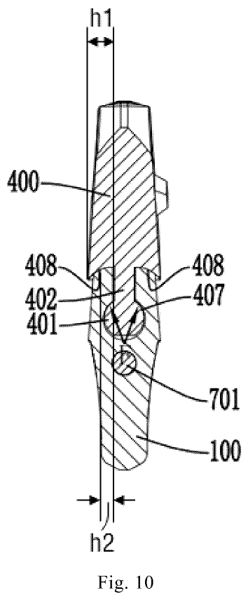

In some embodiments, as shown in FIG. 8 and FIG. 10, the first surface 412 of the clamping groove 406 comprises a first curved surface 408, that is, the clamping groove 406 is formed by the side surface 411 of the neck portion 402 and the first curved surface 408. Correspondingly, the second surface 603 of the top profile 601 of the side wall 600 is arranged as a second curved surface 607 that matches the first curved surface 408. Compared with the figures for embodiment 1, this embodiment replaces the first oblique surface 413 with the first curved surface 408. The first curved surface 408 is formed by obliquely extending towards the handle 100, and the clamping grooves 406 formed thereby constrain the two opposite side walls 600. Preferably, as shown in FIG. 10, a width h1 of the first curved surface 408 is slightly greater than a width h2 of the second curved surface 607.

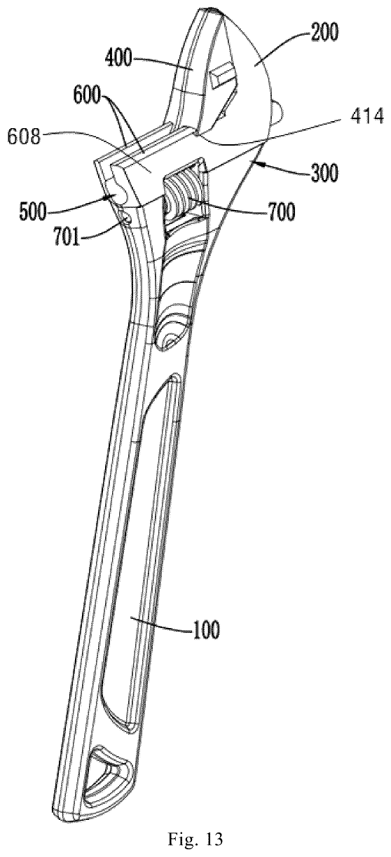

It should be understood that embodiment 1 shows that the first surface 412 comprises a first flat surface 403 and a first inclined surface 404 that is a flat surface, or a first inclined surface 413 that is a flat surface, and embodiment 2 shows that the first surface 412 comprises a first curved surface 408. In other embodiments, the first surface 412 that forms a clamping groove 406 with the side surface 411 of the neck portion 402 may include, but not limited to, the following combinations: (1) two flat surfaces or one curved surface, (2) one flat surface, (3) three or more intersecting flat surfaces, (4) two or more intersecting curved surfaces, or (5) intersecting flat surfaces and curved surfaces (see FIG. 13).

### Embodiment 3

FIG. 13 shows this embodiment. On the basis of embodiments 1-3, this embodiment adds an ear 411 on the outer sides of the clamping grooves 406. Specifically, as shown in the figure, the clamping grooves 406 further comprise an ear 414 opposite to the neck portion 402. The ear 414 extends from an outer edge of the first surface 412 towards the handle 100. When the first surface 412 of the clamping groove 406 contacts the top profile 601 of the side wall 600, an inner side of the ear 414 contacts an outer side surface 608 of the side wall 600, so that the clamping groove 406 better covers the top profile 601 of the side wall 600 and enhances the constraint effect on the side wall 600.

### Embodiment 4

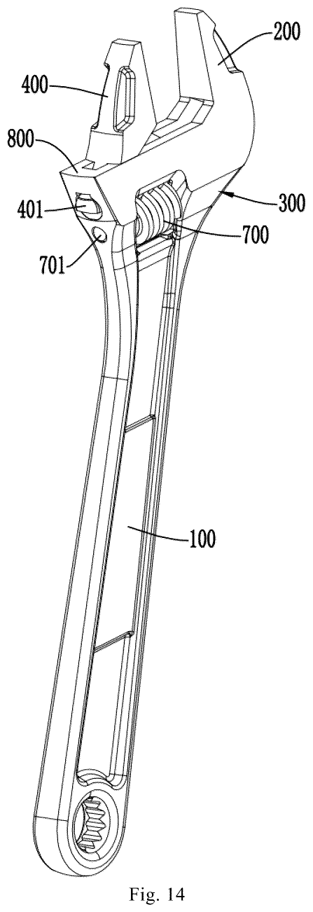

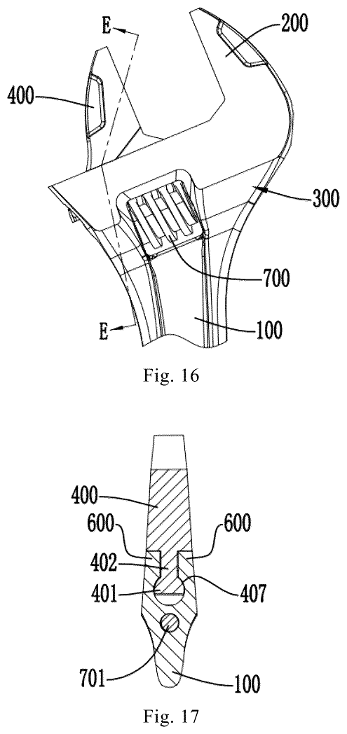

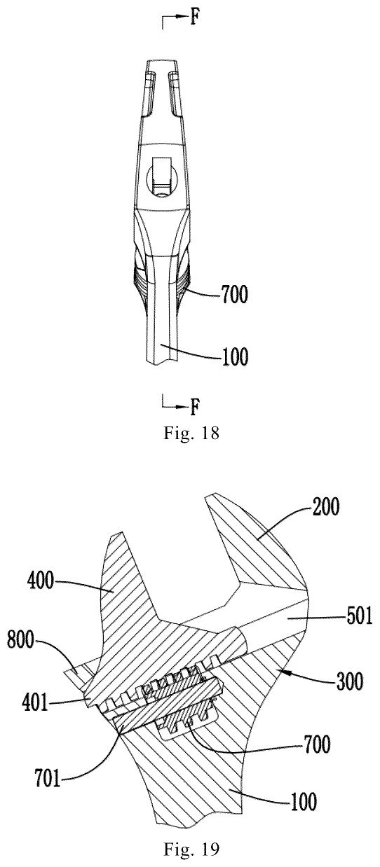

FIG. 14 to FIG. 19 show this embodiment. In this embodiment, a difference of the adjustable wrench from those in embodiments 1-3 lies in that the constraint structure in this embodiment no longer adopts the track slot 500 and the top profiles 601 of the side walls 600 that match the shape of the track slot 500. Other structures in this embodiment, except for the constraint structure, are the same as those in embodiment 1, which will not be repeated.

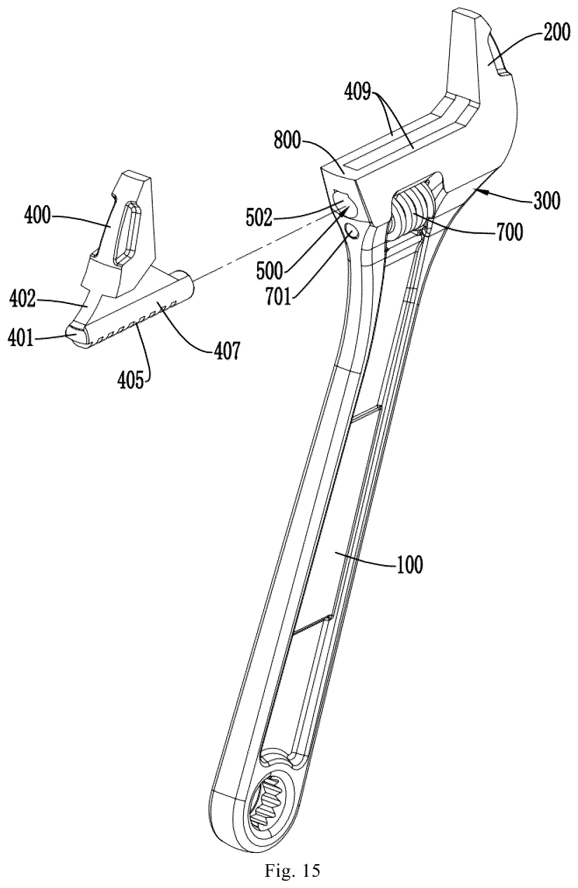

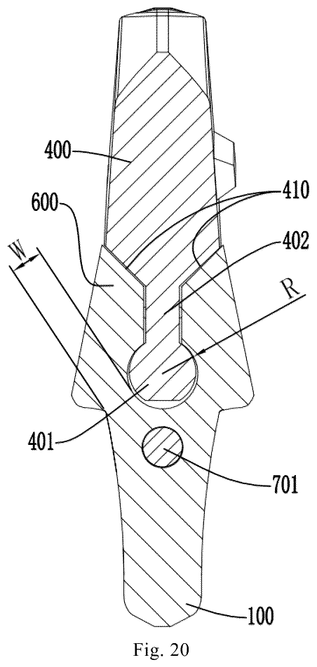

As shown in FIG. 19, one end of the track slot 500 is a closed hole 501, and the closed hole 501 abuts the fixed jaw 200. As shown in FIG. 15, the other end of the track slot 500 is an open end 502, and the open end 502 is far away from the fixed jaw 200; the constraint structure is a reinforcement portion 800 connected between end portions of the two side walls 600 abutting the open end 502. Preferably, the reinforcement portion 800 is a pull rod welded between the two side walls 600. Specifically, after the adjustable jaw 400 is assembled in place, welding is performed and then polishing is performed. In other embodiments, the reinforcement portion 800 may also be a pull rod assembled between the two side walls 600. When the two side walls 600 open or tend to open, the reinforcement portion 800 acts like a pull rod to prevent it. The two side walls 600 open or tend to open, thus increasing the maximum torque applied by the adjustable wrench to the workpiece 900.

In this embodiment, since the constraint structure is implemented by using the reinforcement portion 800, the clamping grooves 406 may be no longer arranged. However, it should be understood that in this embodiment, the clamping grooves 406 may still be arranged as in embodiments 1-3, that is, the constraint structure may comprise both the reinforcement portion 800 and the clamping grooves 406.

### Embodiment 5

FIG. 20 shows this embodiment. In this embodiment, differences of the adjustable wrench from the adjustable wrenches in embodiments 1-4 lie in that the constraint structure is different, and the two sides of the neck portion 402 and the top profiles of the side walls 600 are different from those in embodiments 1-4. Other structures are the same as those in embodiments 1-4, which will not be repeated.

Firstly, in this embodiment, the constraint structure is such that a thickness of the side wall 600 gradually increases from a top surface of the side wall 600 towards the track slot 500. Further, a thickness of a root of the side wall 600 and a radius of the track slot 500 satisfy W≥0.8R, where W is the thickness of the root of the side wall 600 and R is the radius of the track slot 500. By adopting such a structure, since the thickness of the root of the side wall 600 increases, when the two side walls 600 are about to open under the action of the thrust force F, the roots of the side walls 600 can resist such opening, thus maintaining the fit relationship between the worm wheel and the worm 700, and preventing the spacing between the worm wheel and the worm 700 from increasing, so as to increase the maximum torque applied by the adjustable wrench to the workpiece 900.

Secondly, in this embodiment, since the constraint means is achieved by increasing the thickness of the side wall 600, the two sides of the neck portion 402 and the top surfaces of the side walls 600 are inclined flat surfaces 410, and the inclined flat surfaces 410 form obtuse angles with the inner side surfaces of the side walls 600, that is, no clamping grooves 406 are formed on the two sides of the neck portion 402. Accordingly, when the adjustable jaw 400 is subjected to the torque M shown in FIG. 6, left end positions of top surfaces of the side walls 600 apply a resistance force on the adjustable jaw 400 through the inclined flat surfaces 410, preventing the adjustable jaw 400 from being deformed.

In other embodiments, it is not ruled out that the clamping grooves 406 may also be formed on bottom surfaces and the top surfaces of the side walls 600 are adaptively changed when achieving the constraint means by increasing the thickness of the side wall 600.

After testing, the maximum torque applied by the wrench in each embodiment described above to the workpiece 900 can reach 2-2.5 times that of the American standard.

What are described above in detail are specific preferred embodiments of the present invention. It should be understood that those skilled in the art may make various modifications and changes based on the concept of the present invention without contributing any inventive labor. Therefore, any technical solution that can be obtained by those skilled in art based on the concept of the present invention through logical analysis, reasoning, or limited experiments on the basis of the existing technology should also fall within the scope of protection defined by the claims.

1. An adjustable wrench, comprising:
a handle; and
a fixed jaw and an adjustable jaw that are arranged at one end of the handle;
wherein an abutment position of the fixed jaw and the handle is provided with a track slot, and two sides of the track slot extend to form two opposite side walls;
the adjustable jaw comprises a shaft portion, a neck portion, and a clamping portion; the shaft portion is accommodated in the track slot and is configured to move along the track slot; the clamping portion protrudes out of the track slot and is configured to cooperate with the fixed jaw to clamp a workpiece; and the neck portion is located between the two opposite side walls;
wherein the adjustable wrench further comprises a constraint structure, and the constraint structure is configured to prevent the two opposite side walls from opening when applying a torque to the workpiece clamped between the adjustable jaw and the fixed jaw.

2. The adjustable wrench according to claim 1, wherein the constraint structure comprises clamping grooves arranged on two sides of the neck portion and top profiles of the two opposite side walls, wherein openings of the clamping grooves face towards the side walls, shapes of the top profiles match shapes of the clamping grooves, and the top profiles are accommodated in the clamping grooves.

3. The adjustable wrench according to claim 2, wherein the clamping grooves are formed by intersecting a first surface with a side surface of the neck portion, and the first surface at least comprises an inclined surface obliquely extending towards the side walls; and the top profiles comprise a second surface that matches the first surface.

4. The adjustable wrench according to claim 3, wherein the first surface comprises at least two geometric surfaces that are sequentially joined.

5. The adjustable wrench according to claim 4, wherein the first surface comprises a first flat surface and a first inclined surface that are sequentially joined, and the first flat surface intersects with the side surface of the neck portion; the second surface comprises a second flat surface that matches the first flat surface and a second inclined surface that matches the first inclined surface; wherein the first flat surface and the second flat surface are both perpendicular to an inner side surface of the side wall, and the first inclined surface and the second inclined surface respectively form acute angles with the inner side surface of the side wall.

6. The adjustable wrench according to claim 5, wherein the first inclined surface and the second inclined surface are both flat surfaces.

7. The adjustable wrench according to claim 5, wherein the first inclined surface and the second inclined surface are both curved surfaces.

8. The adjustable wrench according to claim 3, wherein the first surface comprises a first oblique surface, and the second surface comprises a second oblique surface that matches the first oblique surface.

9. The adjustable wrench according to claim 8, wherein the first oblique surface and the second oblique surface are both flat surfaces, and the first oblique surface and the second oblique surface respectively form acute angles with an inner side surface of the side wall.

10. The adjustable wrench according to claim 3, wherein the first surface comprises a first curved surface, and the second surface comprises a second curved surface that matches the first curved surface.

11. The adjustable wrench according to claim 10, wherein a width of the first surface is greater than a width of the second surface.

12. The adjustable wrench according to claim 3, wherein the clamping grooves further comprise an ear arranged opposite to the neck portion, the ear extends from an outer side of the first surface towards the handle, and an inner side of the ear contacts an outer side surface of the side wall.

13. The adjustable wrench according to claim 1, wherein one end of the track slot close to the fixed jaw is a closed end, and another end of the track slot is an open end; the constraint structure comprises a reinforcement portion connected between the two opposite side walls, and the reinforcement portion abuts the open end.

14. The adjustable wrench according to claim 13, wherein the reinforcement portion is a rod-shaped member welded between the two opposite side walls.

15. The adjustable wrench according to claim 13, wherein the reinforcement portion is a rod-shaped member assembled between the two opposite side walls.

16. The adjustable wrench according to claim 1, wherein the constraint structure is such that a thickness of the side wall gradually increases from a top surface of the side wall towards the track slot.

17. The adjustable wrench according to claim 16, wherein a thickness W of a root of the side wall and a radius R of the track slot satisfy W≥0.8R.

18. The adjustable wrench according to claim 16, wherein the two sides of the neck portion and top surfaces of the two opposite side walls form inclined flat surfaces, and the inclined flat surfaces form obtuse angles with inner side surfaces of the side walls.

19. The adjustable wrench according to claim 1, wherein the constraint structure is formed by a combination of any two of the following structures or by a combination of the following structures:
i. clamping grooves arranged on two sides of the neck portion and top profiles of the two opposite side walls, wherein openings of the clamping grooves face towards the side walls, shapes of the top profiles match shapes of the clamping grooves, and the top profiles are accommodated in the clamping grooves;
ii. a reinforcement portion connected between the two opposite side walls, wherein the reinforcement portion abuts an open end of the track slot;
iii. a thickness of the side wall gradually increases from a top surface of the side wall towards the track slot.

20. The adjustable wrench according to claim 1, wherein the shaft portion comprises a symmetrical curved surface, and the shaft portion is in sliding fit with a wall of the track slot through the curved surface.
